(19) United States
(12) Patent Application Publication
(10) Pub. No.: US 2026/0155733 A1
(43) Pub. Date: Jun. 4, 2026

(54) METHOD, CONTROLLER, AND COMPUTER PROGRAM FOR OPERATING A THREE-PORT SERIES RESONANCE CONVERTER, CONVERTER ARRANGEMENT, AND COMPUTER-READABLE MEDIUM

(71) Applicant: ABB Schweiz AG, Baden (CH)

(72) Inventors: Julian BOEHLER, Zürich (CH); Sami PETTERSSON, Dietikon (CH); Francisco CANALES, Baden-Dättwil (CH)

(21) Appl. No.: 19/408,529

(22) Filed: Dec. 4, 2025

(30) Foreign Application Priority Data
Dec. 4, 2024 (EP) 24217330.0

(51) Int. Cl. H02M 1/00; H02M 3/00; H02M 3/335

(52) U.S. Cl. CPC H02M 1/0058; H02M 3/01; H02M 3/33515; H02M 3/33573; H02M 3/33592

(57) ABSTRACT

A method for operating a three-port series resonance converter is described. The three-port series resonance converter has a main feeding bridge, at least one auxiliary feeding bridge, and an output bridge. The method comprises sending one or more control signals to one or more switches of the feeding bridges based on a predetermined control scheme such that input voltages applied to the feeding bridges are transformed to an overall output voltage to be provided by the output bridge, and sending a turn off signal to at least some of the switches of at least one of the feeding bridges such that an output voltage of the corresponding feeding bridge is floating, in response to an output bridge current of the output bridge being at least approximately zero.

### CROSS REFERENCE TO RELATED APPLICATIONS

The present application claims priority to European Patent Application No. 24217330.0 filed on Dec. 4, 2024, and titled “METHOD, CONTROLLER, AND COMPUTER PROGRAM FOR OPERATING A THREE-PORT SERIES RESONANCE CONVERTER, CONVERTER ARRANGEMENT, AND COMPUTER-READABLE MEDIUM”, which is hereby incorporated by reference in its entirety.

### TECHNICAL FIELD

The present disclosure relates to the field of electrical converters and to the control of electrical converters. In particular, the present disclosure relates to a method, a controller and, a computer program for controlling a three-port series resonance converter, to a converter arrangement comprising the controller and the three-port series resonance converter, and to a computer-readable medium, on which the computer program is stored.

### BACKGROUND

In general, electrical converters are used for converting an input voltage to an output voltage, for example, from a Low Voltage (LV) to a Medium Voltage (MV) or vice versa. The LV region as used in this description may range from 120 V to 1500 V, and the MV region may refer to voltages larger than 1500 V. One known class of electrical converters is represented by resonance converters, such as for example, a two-port or three-port Series Resonance Converters (SRC).

A two-port SRC has an input bridge and an output bridge coupled to each other by a transformer. A three-port SRC has a main input bridge, an auxiliary input bridge, and an output bridge, wherein each of the input bridges is coupled to the output bridge by a transformer. The two-port as well as the three-port SRC can be operated in two directions, such that in a first operating mode the input voltage is provided to the input bridges and the output voltage is provided by the output bridge and in a second operating mode the input voltage is provided to the output bridge and the output voltage is provided by the input bridges.

One of the advantages of a two-port SRC is that it offers an operating mode called “Half-Cycle Discontinuous Conduction Mode (HC-DCM)”, for which the two-port SRC inherently guarantees soft-switching over the entire operating range while also allowing a very simple open-loop control implementation. In this operating mode, only a feeding bridge of the two-port SRC is actively switched while an output bridge of the two-port SRC is operated as a passive diode rectifier.

The straightforward approach to operate the three-port SRC converter with two feeding bridges would be to also apply the same modulation scheme typically used for the conventional two-port SRC, in other words, actively switching both feeding bridges on the LV side with fixed frequency and full duty cycle based on the corresponding control scheme while the output side bridge on the MV side is operating as a passive diode rectifier. In particular, for a power flow from the MV to the two LV side feeding bridges this can be trivially achieved by applying the same modulation strategy as in case of the two-port SRC. However, in case of a power flow from the two LV feeding bridges to the MV output bridge, the modulation approach used in conventional two-port SRCs leads to circulating currents between two power flow paths, resulting in a loss of soft-switching and reduced power flow controllability, except for some exceptional loading scenarios.

### BRIEF DESCRIPTION

It is an objective of the present disclosure to provide a method, a controller, and a computer program for controlling a three-port SRC, which enable to use the HC-DCM operation for the three-port SRC, in particular if the power flows from the LV feeding bridges towards the MV output bridge, and/or to enable to maintain zero-current switching for the active bridges, in some embodiments, over the entire operating range, and to control a ratio of the power flows between the feeding bridges. It is another object of the present disclosure, to provide a converter arrangement having the controller and the three-port SRC, and a computer-readable medium on which the computer program is stored.

These objectives are achieved by the subject-matter of the independent claims. Further exemplary embodiments are evident from the dependent claims and the following description. The embodiments and features, if any, described in this specification that do not fall under the scope of the independent claim are to be interpreted as examples useful for understanding various embodiments of the present disclosure.

An aspect of the present disclosure relates to a method for operating a three-port series resonance converter. The three-port series resonance converter has a main feeding bridge, at least one auxiliary feeding bridge, and an output bridge. The main feeding bridge is electro-magnetically coupled to the output bridge via a first input coil of the main feeding bridge, the auxiliary feeding bridge is electro-magnetically coupled to the output bridge via a second input coil of the auxiliary feeding bridge, and the main feeding bridge and the auxiliary feeding bridge are configured such that their resonance frequencies are at least approximately the same. The method comprises: sending one or more control signals to one or more switches of the feeding bridges based on a predetermined control scheme such that input voltages applied to the feeding bridges are transformed to an overall output voltage to be provided by the output bridge; and sending a turn off signal to at least some of the switches of at least one of the feeding bridges such that an output voltage of the corresponding feeding bridge is floating, once an output bridge current of the output bridge is at least approximately zero.

Another aspect of the present disclosure relates to a controller for operating the three-port series resonance converter. The controller has a memory for storing one or more voltage values and/or current values; and a processor being communicatively coupled to the memory and being configured to carry out the method as introduced above and described in the following based on the stored voltage values and/or, respectively, current values.

Another aspect of the present disclosure relates to the converter arrangement. The converter arrangement has the three-port SRC, and the controller being communicatively coupled to the three-port SRC and being configured for operating the three-port SRC.

Another aspect of the present disclosure relates to a computer program for operating the three-port SRC, wherein the computer program has computer-readable instructions which, when being executed by the processor of the controller carry out the method as introduced above and described in the following.

Another aspect of the present disclosure relates to a computer-readable medium on which the computer program is stored. The computer-readable medium may be a floppy disk, a hard disk, an USB (Universal Serial Bus) storage device, a RAM (Random Access Memory), a ROM (Read Only Memory), an EPROM (Erasable Programmable Read Only Memory) or a FLASH memory. The computer readable medium may also be a data communication network, for example, the Internet, which allows downloading a program code. In general, the computer-readable medium may be a non-transitory or transitory medium.

It has to be understood that some features of the present disclosure are described with respect to one of the aspects only for conciseness reasons and to avoid unnecessary repetitions, but that these features may be easily transferred to one or more of the other aspects by the person skilled in the art.

The method for operating the three-port SRC represents a new control strategy for the three-port SRC operated with at least two feeding input ports, in other words, the main feeding bridge and the auxiliary feeding bridge. This new method enables to establish a Half-Cycle Discontinuous Conduction Mode (HC-DCM) operation of the three-port SRC similar to a two-port SRC. The proposed method uses a freewheeling state of the feeding bridges to suppress circulating currents between the two feeding ports, which would form between the two feeding bridges if the port power differs from a specific ratio defined by circuit resonance elements of the three-port SRC. With the proposed solution, soft-switching operation of the three-port SRC can be guaranteed while maintaining a simple power flow controllability similar to an operating behavior of a conventional single- or two-port series resonance converter.

In particular, to eliminate the coupling between the two converter paths it is ensured that voltages of leakage inductors of the three-port SRC stay zero during a holdoff interval in which the output bridge current of the output bridge is at least approximately zero. Since the output voltages of the feeding bridges which are provided to the output bridge which acts as the rectifier on the MV side cannot float independently for the corresponding two different current paths, this is accomplished by enabling the Alternating Current (AC) outputs of the actively switched feeding bridges to float during the holdoff time by the turn off signal.

That the output bridge current is “at least approximately zero” may mean that the output bridge current is zero or that a deviation of the output bridge current from zero is smaller than 20%, for example, smaller than 5%, for example, smaller than 0.1%, of a maximal output bridge current of the output bridge. The output bridge current may correspond to a sum of a first transformer current provided by the main feeding bridge and a second transformer current provided by the auxiliary feeding bridge.

That the resonance frequencies of the main feeding bridge and the auxiliary feeding bridge are “at least approximately the same” may mean in this context that the resonance frequencies are the same or that a deviation of the smaller resonance frequency from the larger resonance frequency is smaller than 20%, for example, smaller than 5%, for example, smaller than 0.1%, of the larger resonance frequency.

The main feeding bridge and/or the auxiliary feeding bridge each may be full-bridges having four switches, or half-bridges having two switches. In some embodiments, the three-port SRC may have two or more auxiliary feeding bridges. The output bridge may be used for an active rectification of the output bridge current.

The electro-magnetic coupling of the main feeding bridge to the output bridge via the first input coil and the electro-magnetic coupling of the auxiliary feeding bridge to the output bridge via the second input coil may be realized by the three-port SRC having one single transformer. This single transformer may have one single output coil being electrically coupled with the output bridge and being inductively coupled with the first input coil and with the second input coil. Alternatively, the three-port SRC may have one transformer for each of the feeding bridges. In this case, a first output coil of a first transformer of the three-port series resonance converter may be electrically coupled with the output bridge and electro-magnetically coupled with the first input coil, and a second output coil of a second transformer of the three-port series resonance converter may be electrically coupled with the output bridge and electro-magnetically coupled with the second input coil of the auxiliary feeding bridge.

According to an embodiment of the present disclosure, the method comprises: determining from the predetermined control scheme one or more points in time when the output bridge current is at least approximately zero; and sending the turn off signal to the corresponding switches of the corresponding feeding bridge at the determined points in time. In this embodiment, it may be determined in advance from the predetermined control scheme when the output bridge current is zero and fixed off-times may be provided at the determined points in time each of which being initiated by a corresponding turn off signal. So, it is assumed that the actual output bridge current corresponds to the output bridge current derived from the predetermined control scheme. This enables to realize the fixed off-times without the need for any measurement of the output bridge current. This may contribute to keep the method and the three-port SRC simple.

According to an embodiment of the present disclosure, the method comprises determining a duration during which the output bridge current is at least approximately zero from the predetermined control scheme; and sending one or more control signals based on the predetermined control scheme to activate one or more switches of the feeding bridge, to which the turn off signal was sent, such that the corresponding output voltage is not floating anymore when the duration elapses after sending the turn off signal. The duration may be referred to as hold-off time. The duration may start at each point in time determined from the predetermined control scheme. The turn off signals may always be sent at the beginning of the hold-off intervals and the control signals may always be sent at the end of the hold-off intervals. This enables to realize the off-times without the need for any measurement of the output bridge current. This may contribute to keep the method and the three-port SRC simple.

According to an embodiment of the present disclosure, the method comprises, before sending the turn off signal: receiving at least one current signal being representative of the output bridge current; sending the turn off signal to the corresponding switches of the corresponding feeding bridge once the output bridge current is at least approximately zero; and sending one or more control signals based on the predetermined control scheme to activate one or more switches of the feeding bridge, to which the turn off signal was sent, such that the corresponding output voltage is not floating anymore when the output bridge current is not approximately zero anymore. The current signal may be received continuously and/or during an operation of the three-port SRC and may be monitored with respect to the current signal approaching and/or crossing zero. The current signal may be generated by a current sensor of the converter arrangement and may be sent to the controller. The controller may monitor the current signal from the current sensor with respect to its zero crossing. Determining the hold-off intervals during which the output bridge current is at least approximately zero by measuring the output bridge current may contribute to determine the hold-off intervals very precisely. This may contribute to very low losses when operating the three-port SRC.

According to an embodiment of the present disclosure, when sending the turn off signal to at least some of the switches of at least one of the feeding bridges such that the output voltage of the corresponding feeding bridge is floating, the turn off signal is sent to the main feeding bridge or to the auxiliary feeding bridge, another turn off signal is sent to the other one of the main feeding bridge or the auxiliary feeding bridge, and the main feeding bridge, the auxiliary feeding bridge, and the turn off signals are configured such that all switches of both feeding bridges are turned off while the output bridge current of the output bridge is at least approximately zero. In case of one or both of the feeding bridges being half-bridges, all switches of the corresponding feeding bridge may be turned off by the turn off signal, whereas in case of one or both feeding bridges being full bridges at least three switches of the corresponding feeding bridge may be turned off by the turn off signal.

Alternatively, according to another embodiment of the present disclosure, when sending the turn off signal to at least some of the switches of at least one of the feeding bridges such that the output voltage of the corresponding feeding bridge is floating, the turn off signal is sent to the main feeding bridge or to the auxiliary feeding bridge, and the corresponding feeding bridge and the turn off signal are configured such that all switches of the corresponding feeding bridge are turned off while the output bridge current of the output bridge is at least approximately zero.

In any case, the turn off signal may be one single signal which is sent to each of the corresponding switches. Alternatively, the turn off signal represents a set of individual turn off signals, one for each of the corresponding switches.

These and other aspects of the present disclosure will be apparent from and elucidated with reference to the embodiments described hereinafter.

### BRIEF DESCRIPTION OF DRAWINGS

The subject matter of the present disclosure will be explained in more detail in the following text with reference to exemplary embodiments which are illustrated in the attached drawings.

FIG. 1 shows an electric circuit diagram of an exemplary embodiment of a three-port SRC of the present disclosure.

FIG. 2 shows an equivalent circuit diagram of the three-port SRC of FIG. 1.

FIG. 3 shows an equivalent circuit diagram of the three-port SRC of FIG. 1 in a first state.

FIG. 4 shows an equivalent circuit diagram of the three-port SRC of FIG. 1 in a second state.

FIG. 5 shows examples of voltage and current measurements measured at the three-port SRC of FIG. 1.

FIG. 6 shows an equivalent circuit diagram of the three-port SRC of FIG. 1 in a third state.

FIG. 7 shows a flow diagram of an exemplary embodiment of a method for controlling the three-port SRC of FIG. 1.

The reference symbols used in the drawings, and their meanings, are listed in summary form in the list of reference symbols. In principle, identical parts are provided with the same reference symbols in the figures.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. In some instances, the same or similar components may be assigned a different reference number, for example, due to a different configuration within the electronic circuit. Generally, only the differences with respect to the individual embodiments are described. Unless specified otherwise, the description of a part or aspect in one embodiment applies to a corresponding part or aspect in another embodiment as well.

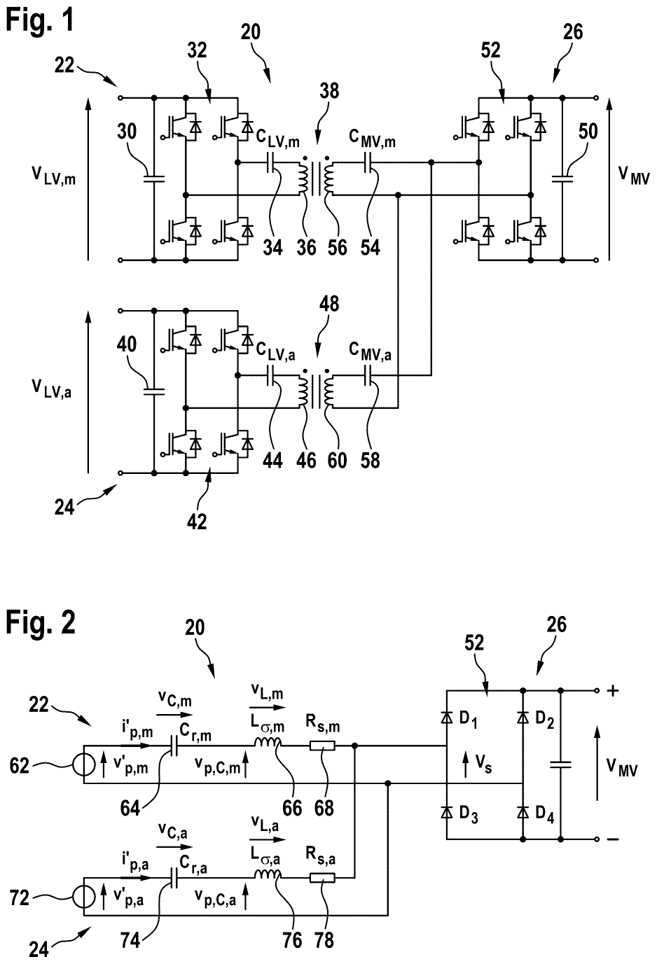

FIG. 1 shows an electric circuit diagram of an exemplary embodiment of a three-port Series Resonance Converter (SRC) 20. The three-port SRC 20 has a main feeding bridge 22, at least one auxiliary feeding bridge 24, and an output bridge 26. In some embodiments, the three-port SRC 20 may have more than one auxiliary feeding bridge 24.

The main feeding bridge 22 has a first DC link 30, at least two, for example, four, first switches 32, a first capacitor input 34 and a first input coil 36. The first switches 32 each may be a semiconductor switch. Each first switch 32 may comprise a dedicated first diode which may act as a freewheeling diode. The first input capacitor 34 has a first input capacitance C_{LV,m}.

The auxiliary feeding bridge 24 has a second DC link 40, at least two, for example, four, second switches 42, a second input capacitor 44 and a second input coil 46. The second switches 42 each may be a semiconductor switch. Each second switch 32 may comprise a dedicated second diode which may act as a freewheeling diode. The second input capacitor 44 has a second input capacitance C_{LV,a}.

The output bridge 26 has an output DC link 50, at least two, for example, four, output switches 52, a first output capacitor 54, a second output capacitor 58, a first output inductance 56, and a second output inductance 60. The output switches 52 each may be a semiconductor switch. Each output switch 52 may comprise a dedicated output diode which may act as a freewheeling diode. The first output capacitor 54 has a first output capacitance C_{MV,m}. The second output capacitor 58 has a second output capacitance C_{MV,a}.

So, the main feeding bridge 22 and the auxiliary feeding bridge 24 each may be full-bridges having four switches 32, 42. Alternatively, the main feeding bridge 22 and the auxiliary feeding bridge 24 each may be half-bridges (not shown) having two switches 32, 42 only.

The main feeding bridge 22 is electro-magnetically coupled to the output bridge 26 via the first input coil 36 of the main feeding bridge 22 and the first output inductance 56 of the output bridge 26. The first output inductance 56 may be provided by a first output coil. The first input coil 36 and the first output coil may form a first transformer 38 of the three-port SRC 20 or may be components of the first transformer 38. The auxiliary feeding bridge 24 is electro-magnetically coupled to the output bridge 26 via the second input coil 46 of the auxiliary feeding bridge 24 and the second output inductance 60 of the output bridge 26. The second output inductance 60 may be provided by a second output coil. The second input coil 46 and the second output coil may form a second transformer 48 of the three-port SRC 20 or may be components of the second transformer 48. Alternatively, the three-port SRC 20 may have only one transformer (not shown) with only one output inductance, for example, one single output coil, wherein both of the input coils 36, 46 may be electro-magnetically coupled to the single output coil.

The main feeding bridge 22 and the auxiliary feeding bridge 24 are configured such that their resonance frequencies are at least approximately the same, as explained below with respect to FIG. 2.

The three-port SRC 22 is configured for receiving a first input voltage V_{LV,m} via the main feeding bridge 22, for receiving a second input voltage V_{LV,a} via the auxiliary feeding bridge 24, and for generating an overall output voltage V_{MV} at an output of the output bridge 26 from the input voltages V_{LV,m}, V_{LV,a}. In this context, the output bridge 26 may be used for an active rectification of an output bridge current provided by the output bridge 26.

To this end, the three-port SRC 22 may be controlled by a controller (not shown) based on a predetermined control scheme. The controller has a memory (not shown) for storing one or more voltage values and/or current values, and a processor (not shown) being communicatively coupled to the memory and being configured to carry out the method as introduced in the foregoing and explained in detail with respect to FIG. 7 based on the stored voltage values and/or, respectively, current values. The controller may be communicatively coupled to the switches 32, 42, 52 of the bridges 22, 24, 26 and may be configured for providing one or more control signals to individually or collectively activate the switches 32, 42, 52 and for providing one or more turn off signal to individually or collectively deactivate, in other words turn off, the switches 32, 42, 52.

Basically, the three-port SRC 20 may be operated vice versa such that an overall input voltage may be provided to the output bridge 20 and that the three-port SRC 20 converts the overall input voltage into individual output voltages provided by the main feeding bridge 22 and, respectively, the auxiliary feeding bridge 24. However, in this case, a conventional method for operating a two-port SRC (not shown) may be used for this alternative power flow direction. Therefore, the present description focusses on the power flow from the feeding bridges 22, 24 to the output bridge 26.

The three-port SRC 20 and the controller being communicatively coupled to the three-port SRC 20 may form a converter arrangement or may be part of a converter arrangement.

FIG. 2 shows an equivalent circuit diagram of the three-port SRC of FIG. 1. The first DC link 30 and the first switches 32 of the main feeding bridge 22 are represented by a first ideal voltage source 62. The second DC link 40 and the second switches 42 of the auxiliary feeding bridge 24 are represented by a second ideal voltage source 72.

The first input capacitor 34 and the first output capacitor 54 may be represented by a first substitute capacitor 64. As such, the first input capacitance C_{LV,m} and the first output capacitance C_{MV,m} may be summarized into a first resonance capacitance C_{r,m}. The second input capacitor 44 and the second output capacitor 58 may be represented by a second substitute capacitor 74. As such, the second input capacitance C_{LV,a} and the second output capacitance C_{MV,a} may be summarized into a second resonance capacitance C_{r,a}.

The first transformer 38 may be represented by a first substitute inductance 66 and may be modelled by a first leakage inductance L_{σ,m}. The second transformer 48 may be represented by a second substitute inductance 76 and may be modelled by a second leakage inductance L_{σ,a}.

A first substitute resistor 68 may represent conduction losses of the first switches 32, the first diodes, the first transformer 38, and the output switches 52 and may be neglected in the following. A second substitute resistor 78 may represent conduction losses of the second switches 42, the second diodes, the second transformer 58, and the output switches 52 and may be neglected in the following.

The output switches 52 are represented by their output diodes which are referred to by D1, D2, D3, and D4, in FIG. 2.

A first resonance frequency ωₘ of the main feeding bridge 22 may be given by

$${ω}_{m} = \frac{1}{\sqrt{{L}_{σ , m} {C}_{r , m}}} .$$

A second resonance frequency ωₐ of the auxiliary feeding bridge 24 may be given by

$${ω}_{a} = \frac{1}{\sqrt{{L}_{σ , a} {C}_{r , a}}} .$$

The leakage inductances L_{σ,m}, L_{σ,a} and the resonance capacitances C_{r,m}, C_{r,a} are chosen such that the first resonance frequency Om and the second resonance frequency ωₐ are at least approximately the same.

The first ideal voltage source 62 may provide a first output voltage v′_{p,m}. The first output voltage v′_{p,m} may cause a first transformer current i′_{p,m} which may lead to a first capacitor voltage v_{C,m} over the first substitute capacitor 64, to a first primary capacitor voltage V_{p,C,m} between the two parallel lines of the main feeding bridge 22, and to a first inductor voltage V_{L,m} over the first substitute inductance 66. It has to be mentioned in this context, that all quantities characterized by the apostrophe “′” are quantities scaled by the turn ratios of their respective transformers of the three-port SRC 20. In particular, in this description, the LV side quantities are scaled up to the MV quantities to enhance the calculability, as it is known in the art.

Similarly, the second ideal voltage source 72 may provide a second output voltage v′_{p,a}. The second output voltage v′_{p,a} may cause a second transformer current i′_{p,a} which may lead to a second capacitor voltage v_{C,a} over the second substitute capacitor 74, to a second primary capacitor voltage v_{p,C,a} between the two parallel lines of the auxiliary feeding bridge 24, and to a second inductor voltage V_{L,a} over the second substitute inductance 76.

These voltages cause a resulting voltage vₛ in the output bridge 26. The transformer currents i′_{p,m}, i′_{p,a} may be summed up to get the output bridge current of the three-port SRC 20. In other words, the output bridge current of the three-port SRC 20 may correspond to the sum of the transformer currents i′_{p,m}, i′_{p,a}.

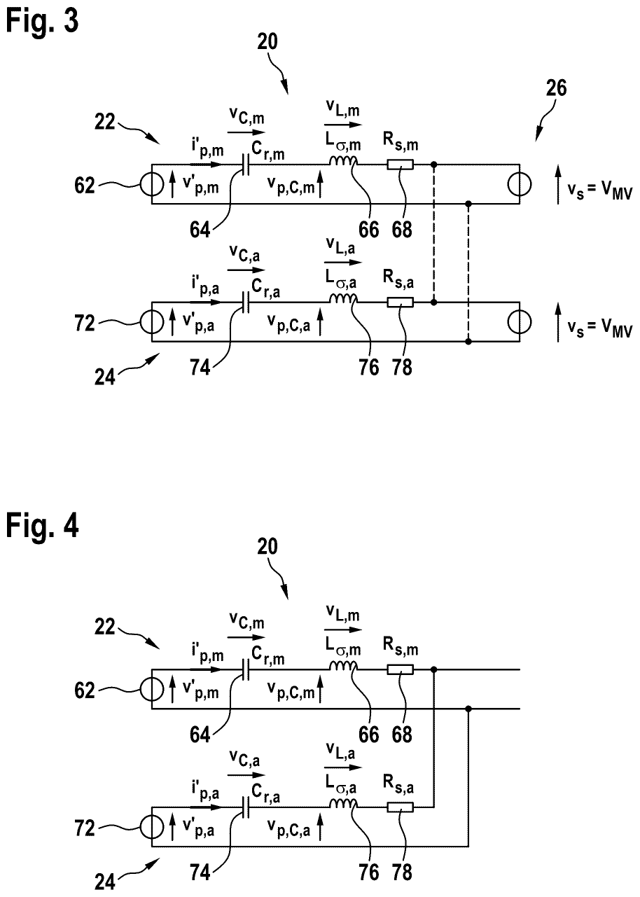

FIG. 3 shows an equivalent circuit diagram of the three-port SRC 20 of FIG. 1 in a first state. The first state represents an active interval of a positive half-cycle of a predetermined control scheme for operating the three-port SRC 20. During the active interval, the diodes D1 and D4 (see FIG. 2) are conducting and the overall output voltage V_{MV} is applied to both feeding bridges 22, 24. The two transformer currents i′_{p,m}, i′_{p,a} may be determined independent of each other and by the resonance elements, in other words, the substitute capacitors 64, 74 and the substitute inductances 66, 76.

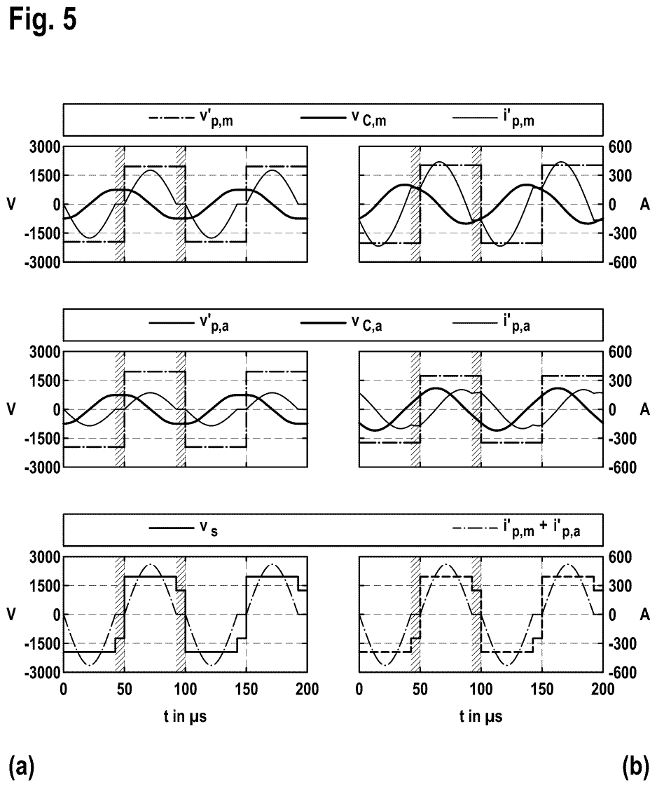

During the active interval, the output bridge current is neither zero nor approximately zero, as defined in this description and as further explained with respect to FIG. 5.

FIG. 4 shows the equivalent circuit diagram of the three-port SRC 20 of FIG. 1 in a second state. The second state represents a holdoff interval where the output bridge 26 acts as the diode rectifier and is blocking. Due to the parallel connection of the resonance elements of the two feeding bridges 22, 24, the resulting voltage vₛ cannot float independently and circulating currents between the two feeding bridges 22, 24 may occur. In particular, the transformer currents i′_{p,m}, i′_{p,a} may not be at least approximately zero during the holdoff interval, as explained in more detail with respect to FIG. 5.

The transformer currents i′_{p,m}, i′_{p,a} not being zero or at least approximately zero during the holdoff interval implies non-soft-switching operation at the end of the holdoff interval what may lead to high losses. Therefore, this second state, in particular the circulating currents during the holdoff interval, shall be avoided.

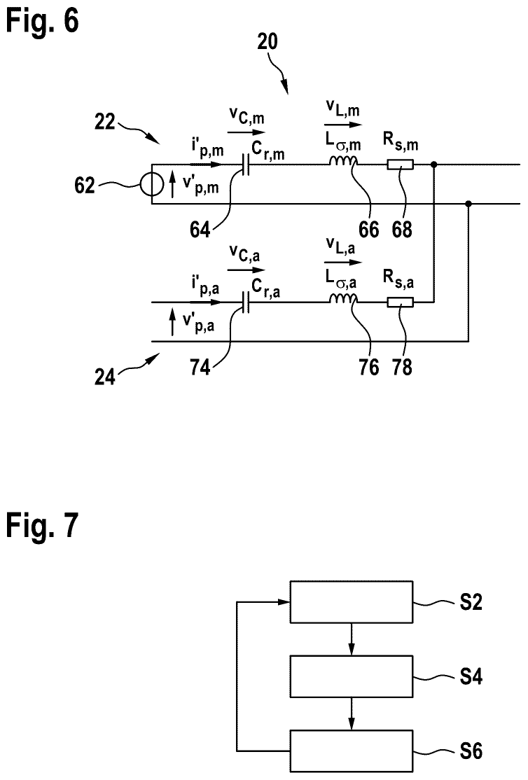

However, there is only one situation in which the transformer currents i′_{p,m}, i′_{p,a} are zero or at least approximately zero during the holdoff interval, as explained in the following, and for all other situations the method for operating the three-port SRC 20 as explained with respect to FIGS. 6 and 7 can be applied.

In fact, the following condition has to be ensured if the transformer currents i′_{p,m}, i′_{p,a} should stay zero or at least approximately zero during the holdoff time interval:

$${v}_{p , C , m} - {v}_{p , C , a} = 0 ,$$

in other words, the sum of one of the output voltages v′_{p,m}, v′_{p,a} and the corresponding capacitor voltage v_{C,m}, V_{C,a} has to be equal for both feeding bridges 22, 24. Considering equal LV-side DC-link voltages V′_{LV,m} and V′_{LV,a}, this condition translates to

$${v}_{p , m}^{′} {+}_{C , m} - {v}_{p , a}^{′} - {v}_{C , a} = {v}_{C , m} - {v}_{C , a} = 0.$$

Since the capacitor voltages v_{C,m}, V_{C,a} are defined by their according power flow, the above equation implies

$$\frac{{P}_{m}}{4 {V}_{MV} {f}_{sw} {C}_{r , m}} = {v}_{C , a} = {v}_{C , m} = \frac{{P}_{a}}{4 {V}_{MV} {f}_{sw} {C}_{r , a}} .$$

Pₘ denotes the power flowing through the main feeding bridge 22 and Pa denotes the power flowing through the auxiliary feeding bridge 24.

Simplifying this expression leads to

$$\frac{{P}_{m}}{{P}_{a}} = \frac{{C}_{r , m}}{{C}_{r , a}} = \frac{{L}_{σ , a}}{{L}_{σ , m}}$$

also referred to as “natural loading” in the following.

So, when the power flow and the resonance elements of the feeding bridges 22, 24 are such that the natural loading is given, no problem arises and a conventional control scheme may be used for operating the three-port SRC 20. In all other cases, the new method explained with respect to FIGS. 6 and 7 can be used to enable soft switching operations.

FIG. 5 shows examples of voltage and current measurements measured at the three-port SRC 20 of FIG. 1. The diagrams on the left show the situation when the natural loading is given and the diagrams on the right show the situation when the natural loading is not given.

The diagrams in the first line show the first output voltage v′_{p,m}, the first capacitor voltage v_{C,m}, and the first transformer current i′_{p,m} in the main feeding bridge 22. The diagrams in the second line show the second output voltage v′_{p,a}, the second capacitor voltage V_{C,a}, and the second transformer current i′_{p,a} in the auxiliary feeding bridge 24. The diagrams in the third line show the resulting voltage vₛ, and the output bridge current corresponding to the sum of the transformer currents i′_{p,m}, i′_{p,a} in the output bridge 26.

As may be seen from the diagrams on the left in the first two lines, the transformer currents i′_{p,m}, i′_{p,a} rise up from zero at each rising edge of the corresponding output voltage v′_{p,m}, v′_{p,a}, wherein the edges of the output voltage v′_{p,m}, v′_{p,a} mark switching operations according to a predetermined control scheme. Similarly, the transformer currents i′_{p,m}, i′_{p,a} go down from zero at each falling edge of the corresponding output voltage v′_{p,m}, v′_{p,a}. However, shortly before the rising or falling edges of the output voltages v′_{p,m}, v′_{p,a} the corresponding transformer current i′_{p,m}, i′_{p,a} is zero or at least approximately zero. These phases during which the transformer currents i′_{p,m}, i′_{p,a} are zero or at least approximately zero are the above-mentioned holdoff intervals, whereas the phases between the holdoff intervals are the active intervals.

So, in case of the natural loading all of the currents i′_{p,m}, i′_{p,a}, and i′_{p,m}+i′_{p,a} are zero during the holdoff interval and soft switching may be carried out during the holdoff interval.

In contrast, when no natural loading is given, as shown in the diagrams on the right, the transformer currents i′_{p,m}, i′_{p,a} are neither zero nor approximately zero during the holdoff interval, in other words, during the output bridge current i′_{p,m}+i′_{p,a} is zero, because of the circulating currents explained with respect to FIG. 4. In this case, soft switching cannot be accomplished without further measures. At least one of these measures is given by the method for operating the three-port SRC 20 as explained in the following.

FIG. 6 shows the equivalent circuit diagram of the three-port SRC 20 of FIG. 1 in a third state. In the first state, at least one of the feeding bridges 22, 24, for example, the auxiliary feeding bridge 24, is controlled such that the corresponding output voltage v′_{p,m}, v′_{p,a} is floating.

In particular, in order to eliminate the coupling between the two feeding bridges 22, 24 during the holdoff interval it may be ensured that the inductor voltages V_{L,m}, V_{L,a} stay zero during the holdoff interval. Since the resulting voltage vₛ of the output bridge 26 cannot float independently for the two feeding bridges 22, 24, this is accomplished by enabling at least one of the AC outputs of the actively switched feeding bridges 22, 24 on the LV side to float during the holdoff time. This may be achieved by turning off all four switches of one (or both) of the feeding bridges 22, 24 once the three-port SRC 20 enters the holdoff interval in which the output bridge current is zero.

Due to the absence of a close current path, no circulating currents can flow. The turn-off of the corresponding feeding bridge 22, 24 may be triggered either setting a fixed on-time of the corresponding feeding bridge 22, 24, or by synchronizing the turn-off to the zero-crossing of the transformer currents i′_{p,m}, i′_{p,a}, which may be measured in this case, as explained in more detail with respect to FIG. 7.

If only one of the two feeding bridges 22, 24 is turned off during the holdoff interval, it has to be ensured that the resulting floating potential of the deactivated feeding bridge 22, 24 stays within its DC-link voltage range, otherwise it will act as a diode rectifier that is driven into conduction by the other one of the two feeding bridges 22, 24 and the two substitute capacitors 64, 74. This may be seen from FIG. 6, where the auxiliary feeding bridge 24 is exemplarily deactivated while the main feeding bridge 22 stays active during the holdoff interval. Considering the positive half-period (in other words, v′_{p,m}=+V′L_{V,m}) the resulting output voltage v′_{p,a} of the auxiliary feeding bridge 22 results in

$${v}_{p , a}^{′} = {v}_{p , m}^{′} + {v}_{C , m} - {v}_{C , a} = {V}_{LV , m}^{′} - \frac{{P}_{m}}{4 {V}_{MV} {f}_{sw} {C}_{r , m}} + \frac{{P}_{a}}{4 {V}_{MV} {f}_{sw} {C}_{r , a}} < {V}_{LV , a}^{′} ,$$

which has to stay within a range of ±V′L_{V,a} in order to keep the freewheeling diodes of the auxiliary feeding bridge 24 blocked. Consequently, this results in the following condition since V′_{LV,m}=V′_{LV,a} applies:

$$\frac{{P}_{a}}{{P}_{m}} < \frac{{C}_{r , a}}{{C}_{r , m}} = \frac{{L}_{r , m}}{{L}_{r , a}}$$

and vice versa if the main feeding bridge 22 is deactivated and the auxiliary feeding bridge 24 stays active. The feeding bridge 22, 24 that has to be floating if only one of the two feeding bridges 22, 24 is deactivated is therefore always the one, for which the portion of the output power is smaller than what would result from the ideal ratio given by the ratio of the reactive elements in the above Equation (1).

FIG. 7 shows a flow diagram of an exemplary embodiment of a method for controlling the three-port SRC 20 of FIG. 1.

In an activity S2, one or more control signals are sent to one or more switches 32, 42 of the feeding bridges 22, 24 based on a predetermined control scheme such that the input voltages VLV,m, VLV,a applied to the feeding bridges 22, 24 are transformed to the output bridge voltage to be provided by the output bridge 26. This activity may be carried out continuously while operating the three-port SRC 20. The predetermined control scheme may be based on Pulse Width Modulation (PWM) or on Model Predictive Control (MPC), for example.

In an activity S4, it may be determined that the output bridge current of the output bridge 26 is at least approximately zero.

In an activity S6, a turn off signal may be sent to at least some of the switches 32, 42 of at least one of the feeding bridges 22, 24 such that an output voltage v′_{p,m}, v′_{p,a} of the corresponding feeding bridge 22, 24 is floating.

In above activity 4, one or more points in time when the output bridge current is at least approximately zero may be determined from the predetermined control scheme to determine whether the output bridge current of the output bridge 26 is at least approximately zero or not. In this case, the turn off signal may be sent to the corresponding switches 32, 42 of the corresponding feeding bridge 22, 24 in activity S6 at the determined points in time. In this embodiment, it may be determined in advance from the predetermined control scheme when the output bridge current is zero and fixed off-times may be provided at the determined points in time each of which being initiated by a corresponding turn off signal. So, in this embodiment, it is assumed that the actual output bridge current corresponds to the output bridge current derived from the predetermined control scheme.

Further, in this embodiment, a duration during which the output bridge current is at least approximately zero may be determined from the predetermined control scheme. Then, one or more control signals may be sent based on the predetermined control scheme to activate one or more switches 32, 42 of the feeding bridge 22, 24, to which the turn off signal was sent, such that the corresponding output voltage v′_{p,m}, v′_{p,a} is not floating anymore when the duration elapses after sending the turn off signal. This may correspond to proceed with the method in activity S2. The duration may be referred to as the hold-off time. The duration may start at each point in time determined from the predetermined control scheme in activity S4. The turn off signals may always be sent at the beginning of the hold-off intervals and the control signals may always be sent at the end of the hold-off intervals.

Alternatively, in activity S4, at least one current signal being representative of the output bridge current may be received. In this case, the turn off signal may be sent to the corresponding switches 32, 42 of the corresponding feeding bridge 22, 24 in activity S6 once the output bridge current is at least approximately zero. Then, one or more control signals may be sent based on the predetermined control scheme to activate one or more switches 32, 42 of the feeding bridge 22, 24, to which the turn off signal was sent, such that the corresponding output voltage v′_{p,m}, v′_{p,a} is not floating anymore when the output bridge current is not approximately zero anymore. This may correspond to proceed with the method in activity S2. The current signal may be received continuously and/or during an operation of the three-port SRC 20 and may be monitored with respect to the current signal approaching and/or crossing zero. The current signal may be generated by a current sensor of the converter arrangement and may be sent to the controller. The controller may monitor the current signal from the current sensor with respect to its zero crossing.

Independent from which of the above two embodiments is used, when sending the turn off signal to at least some of the switches 32, 42 of at least one of the feeding bridges 22, 24 such that the output voltage v′_{p,m}, v′_{p,a} of the corresponding feeding bridge 22, 24 is floating, the turn off signal may be sent to the main feeding bridge 22 or to the auxiliary feeding bridge 24, another turn off signal may be sent to the other one of the main feeding bridge 22 or the auxiliary feeding bridge 24, and the main feeding bridge 22, the auxiliary feeding bridge 24, and the turn off signals may be configured such that all switches 32, 42 of both feeding bridges are turned off while the output bridge current of the output bridge 26 is at least approximately zero. In case of one or both of the feeding bridges 22, 24 being half-bridges, all switches 32, 42 of the corresponding feeding bridge 22, 24 may be turned off by the turn off signal, whereas in case of one or both feeding bridges 22, 24 being full bridges at least three switches 32, 42 of the corresponding feeding bridge 22, 24 may be turned off by the turn off signal.

Alternatively, when sending the turn off signal to at least some of the switches 32, 42 of at least one of the feeding bridges 22, 24 such that the output voltage of the corresponding feeding bridge 22, 24 is floating, the turn off signal may be sent to the main feeding bridge 22 or to the auxiliary feeding bridge 24, and the corresponding feeding bridge 22, 24 and the turn off signal are configured such that all switches 32, 42 of the corresponding feeding bridge 22, 24 are turned off while the output bridge current of the output bridge 26 is at least approximately zero.

The method for controlling the three-port SRC 20 may be embodied as a computer program for operating the three-port SRC 20. The computer program has computer-readable instructions which, when being executed by the processor of the controller for controlling the three-port SRC 20 carry out the method for controlling the three-port SRC 20 as described in the foregoing. The computer program may be stored on a computer-readable medium. The computer-readable medium may be a floppy disk, a hard disk, an USB (Universal Serial Bus) storage device, a RAM (Random Access Memory), a ROM (Read Only Memory), an EPROM (Erasable Programmable Read Only Memory) or a FLASH memory. The computer readable medium may also be a data communication network, for example, the Internet, which allows downloading a program code. In general, the computer-readable medium may be a non-transitory or transitory medium.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practicing the present disclosure, from a study of the drawings, the disclosure, and the appended claims. In the claims, the word “comprising” does not exclude other elements or activities, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method for operating a three-port series resonance converter, wherein the three-port series resonance converter has a main feeding bridge, at least one auxiliary feeding bridge, and an output bridge, the main feeding bridge is electro-magnetically coupled to the output bridge via a first input coil of the main feeding bridge, the auxiliary feeding bridge is electro-magnetically coupled to the output bridge via a second input coil of the auxiliary feeding bridge, and resonance frequencies of the main feeding bridge and the auxiliary feeding bridge are at least approximately the same, the method comprising:
sending one or more control signals to one or more switches of the feeding bridges based on a predetermined control scheme such that input voltages applied to the feeding bridges are transformed to an overall output voltage to be provided by the output bridge; and
sending a turn off signal to at least some of the switches of at least one of the feeding bridges such that an output voltage of the corresponding feeding bridge is floating, in response to an output bridge current of the output bridge being at least approximately zero.

2. The method according to claim 1, further comprising:
determining from the predetermined control scheme one or more points in time when the output bridge current is at least approximately zero; and
sending the turn off signal to the corresponding switches of the corresponding feeding bridge at the determined points in time.

3. The method according to claim 2, further comprising:
determining a duration during which the output bridge current is at least approximately zero from the predetermined control scheme; and
sending one or more control signals based on the predetermined control scheme to activate one or more switches of the feeding bridge, to which the turn off signal was sent, such that the corresponding output voltage is not floating anymore when the duration elapses after sending the turn off signal.

4. The method according to claim 1, before sending the turn off signal comprising:
receiving at least one current signal representative of the output bridge current;
sending the turn off signal to the corresponding switches of the corresponding feeding bridge once in response to the output bridge current being at least approximately zero; and
sending one or more control signals based on the predetermined control scheme to activate one or more switches of the feeding bridge, to which the turn off signal was sent, such that the corresponding output voltage is no longer floating when the output bridge current is no longer approximately zero.

5. The method according to claim 1, wherein:
when sending the turn off signal to at least some of the switches of at least one of the feeding bridges such that the output voltage of the corresponding feeding bridge is floating,
the turn off signal is sent to the main feeding bridge or to the auxiliary feeding bridge,
another turn off signal is sent to the other one of the main feeding bridge or the auxiliary feeding bridge, and
the main feeding bridge, the auxiliary feeding bridge, and the turn off signals are configured such that the switches of both feeding bridges are turned off while the output bridge current of the output bridge is at least approximately zero.

6. The method according to claim 1, wherein:
when sending the turn off signal to at least some of the switches of at least one of the feeding bridges such that the output voltage of the corresponding feeding bridge is floating,
the turn off signal is sent to the main feeding bridge or to the auxiliary feeding bridge, and
the corresponding feeding bridge and the turn off signal are configured such that the switches of the corresponding feeding bridge are turned off while the output bridge current of the output bridge is at least approximately zero.

7. (canceled)

8. A converter arrangement, comprising:
a three-port series resonance converter, wherein the three-port series resonance converter has a main feeding bridge, at least one auxiliary feeding bridge, and an output bridge, the main feeding bridge is electro-magnetically coupled to the output bridge via a first input coil of the main feeding bridge, the auxiliary feeding bridge is electro-magnetically coupled to the output bridge via a second input coil of the auxiliary feeding bridge, and resonance frequencies of the main feeding bridge and the auxiliary feeding bridge are at least approximately the same; and
a controller, which is communicatively coupled to the three-port series resonance converter and operates the three-port series resonance converter, wherein the controller comprises:
a memory configured to store one or more voltage values and/or current values; and
a processor communicatively coupled to the memory and configured to, based on the stored voltage values and/or, respectively, current values:
send one or more control signals to one or more switches of the feeding bridges based on a predetermined control scheme such that input voltages applied to the feeding bridges are transformed to an overall output voltage to be provided by the output bridge; and
send a turn off signal to at least some of the switches of at least one of the feeding bridges such that an output voltage of the corresponding feeding bridge is floating, in response to an output bridge current of the output bridge being at least approximately zero.

9. (canceled)

10. A non-transitory computer-readable medium for operating a three-port series resonance converter,
wherein the three-port series resonance converter has a main feeding bridge, at least one auxiliary feeding bridge, and an output bridge, the main feeding bridge is electro-magnetically coupled to the output bridge via a first input coil of the main feeding bridge, the auxiliary feeding bridge is electro-magnetically coupled to the output bridge via a second input coil of the auxiliary feeding bridge, and resonance frequencies of the main feeding bridge and the auxiliary feeding bridge are at least approximately the same, and
wherein the non-transitory computer-readable medium comprises programmed instructions which, when executed by at least one processor of a controller, wherein the controller is communicatively coupled to the three-port series resonance converter, and the controller comprises a memory which is communicatively coupled to the at least one processor and configured to store one or more voltage values and/or current values, cause the at least one processor to, based on the stored voltage values and/or, respectively, current values:
send one or more control signals to one or more switches of the feeding bridges based on a predetermined control scheme such that input voltages applied to the feeding bridges are transformed to an overall output voltage to be provided by the output bridge; and
send a turn off signal to at least some of the switches of at least one of the feeding bridges such that an output voltage of the corresponding feeding bridge is floating, in response to an output bridge current of the output bridge being at least approximately zero.

11. The converter arrangement according to claim 8, wherein the processor is further configured to:
determine from the predetermined control scheme one or more points in time when the output bridge current is at least approximately zero; and
send the turn off signal to the corresponding switches of the corresponding feeding bridge at the determined points in time.

12. The converter arrangement according to claim 11, wherein the processor is further configured to:
determine a duration during which the output bridge current is at least approximately zero from the predetermined control scheme; and
send one or more control signals based on the predetermined control scheme to activate one or more switches of the feeding bridge, to which the turn off signal was sent, such that the corresponding output voltage is no longer floating when the duration elapses after sending the turn off signal.

13. The converter arrangement according to claim 8, wherein before sending the turn off signal, the processor is further configured to:
receive at least one current signal representative of the output bridge current;
send the turn off signal to the corresponding switches of the corresponding feeding bridge in response to the output bridge current being at least approximately zero; and
send one or more control signals based on the predetermined control scheme to activate one or more switches of the feeding bridge, to which the turn off signal was sent, such that the corresponding output voltage is no longer floating when the output bridge current is no longer approximately zero.

14. The converter arrangement according to claim 8, wherein:
when sending the turn off signal to at least some of the switches of at least one of the feeding bridges such that the output voltage of the corresponding feeding bridge is floating,
the turn off signal is sent to the main feeding bridge or to the auxiliary feeding bridge,
another turn off signal is sent to the other one of the main feeding bridge or the auxiliary feeding bridge, and
the main feeding bridge, the auxiliary feeding bridge, and the turn off signals are configured such that the switches of both feeding bridges are turned off while the output bridge current of the output bridge is at least approximately zero.

15. The converter arrangement according to claim 8, wherein:
when sending the turn off signal to at least some of the switches of at least one of the feeding bridges such that the output voltage of the corresponding feeding bridge is floating,
the turn off signal is sent to the main feeding bridge or to the auxiliary feeding bridge, and
the corresponding feeding bridge and the turn off signal are configured such that the switches of the corresponding feeding bridge are turned off while the output bridge current of the output bridge is at least approximately zero.

16. The non-transitory computer-readable medium according to claim 10, wherein the programmed instructions further cause the at least one processor to:
determine from the predetermined control scheme one or more points in time when the output bridge current is at least approximately zero; and
send the turn off signal to the corresponding switches of the corresponding feeding bridge at the determined points in time.

17. The non-transitory computer-readable medium according to claim 16, wherein the programmed instructions further cause the at least one processor to:
determine a duration during which the output bridge current is at least approximately zero from the predetermined control scheme; and
send one or more control signals based on the predetermined control scheme to activate one or more switches of the feeding bridge, to which the turn off signal was sent, such that the corresponding output voltage is no longer floating when the duration elapses after sending the turn off signal.

18. The non-transitory computer-readable medium according to claim 10, wherein before sending the turn off signal, the programmed instructions further cause the at least one processor to:
receive at least one current signal representative of the output bridge current;
send the turn off signal to the corresponding switches of the corresponding feeding bridge in response to the output bridge current being at least approximately zero; and
send one or more control signals based on the predetermined control scheme to activate one or more switches of the feeding bridge, to which the turn off signal was sent, such that the corresponding output voltage is no longer floating when the output bridge current is no longer approximately zero.

19. The non-transitory computer-readable medium according to claim 10, wherein, when sending the turn off signal to at least some of the switches of at least one of the feeding bridges such that the output voltage of the corresponding feeding bridge is floating,
the turn off signal is sent to the main feeding bridge or to the auxiliary feeding bridge,
another turn off signal is sent to the other one of the main feeding bridge or the auxiliary feeding bridge, and
the main feeding bridge, the auxiliary feeding bridge, and the turn off signals are configured such that the switches of both feeding bridges are turned off while the output bridge current of the output bridge is at least approximately zero.

20. The non-transitory computer-readable medium according to claim 10, wherein, when sending the turn off signal to at least some of the switches of at least one of the feeding bridges such that the output voltage of the corresponding feeding bridge is floating,
the turn off signal is sent to the main feeding bridge or to the auxiliary feeding bridge, and
the corresponding feeding bridge and the turn off signal are configured such that the switches of the corresponding feeding bridge are turned off while the output bridge current of the output bridge is at least approximately zero.

21. The method according to claim 2, wherein:
when sending the turn off signal to at least some of the switches of at least one of the feeding bridges such that the output voltage of the corresponding feeding bridge is floating,
the turn off signal is sent to the main feeding bridge or to the auxiliary feeding bridge,
another turn off signal is sent to the other one of the main feeding bridge or the auxiliary feeding bridge, and
the main feeding bridge, the auxiliary feeding bridge, and the turn off signals are configured such that the switches of both feeding bridges are turned off while the output bridge current of the output bridge is at least approximately zero.

22. The method according to claim 2, wherein:
when sending the turn off signal to at least some of the switches of at least one of the feeding bridges such that the output voltage of the corresponding feeding bridge is floating,
the turn off signal is sent to the main feeding bridge or to the auxiliary feeding bridge, and
the corresponding feeding bridge and the turn off signal are configured such that the switches of the corresponding feeding bridge are turned off while the output bridge current of the output bridge is at least approximately zero.
